(19) United States
(12) Patent Application Publication
(10) Pub. No.: US 2025/0254753 A1
(43) Pub. Date: Aug. 7, 2025

(54) FRAMEWORK FOR SETTING ACCESS LAYER PARAMETERS BASED ON DEVICE INPUT

(71) Applicant: QUALCOMM Incorporated, San Diego, CA (US)

(72) Inventors: ChaoFeng HUI, Beijing (CN); Yuankun ZHU, Shanghai (CN); Fojian ZHANG, Shenzhen (CN); Zhuoqi XU, Shanghai (CN); Pan JIANG, Shanghai (CN)

(21) Appl. No.: 18/706,543

(22) PCT Filed: Jan. 12, 2022
(86) PCT No.: PCT/CN2022/071535

§ 371 Date: May 1, 2024

(51) Int. Cl. H04W 76/28; H04W 72/21

(52) U.S. Cl. CPC H04W 76/28; H04W 72/21

(57) ABSTRACT

A method of wireless communication performed by a user equipment (UE) includes: receiving input specifying an operational characteristic of the UE; communicating from an operating system of the UE to a logic component by an application programming interface (API), including communicating an indication of the input to the logic component, which is separate from the operating system and executed by a chipset of the UE; mapping the operational characteristic of the UE to an access layer parameter, wherein mapping the operational characteristic is performed by the logic component; negotiating the access layer parameter with a network serving the UE; receiving a configuration from the network, the configuration being related to the access layer parameter; and communicating with the network according to the access layer parameter.

### TECHNICAL FIELD

This application relates to wireless communication systems, and more particularly to setting access layer parameters in a wireless device based on device input.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum.

NR technology may also make use of a variety of different base station and user equipment technologies to maintain communication at acceptable throughput rates. With the different base station and user equipment technologies comes a variety of different parameters that may be set for user equipment communication. There is a need in the art for efficient and user-satisfying techniques to set parameters for user equipment communication.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication is performed by a user equipment (UE). The method of wireless communication also includes receiving input specifying an operational characteristic of the UE; communicating from an operating system of the UE to a logic component by an application programming interface (API), including communicating an indication of the input to the logic component, which is separate from the operating system and executed by a chipset of the UE; mapping the operational characteristic of the UE to an access layer parameter, where mapping the operational characteristic is performed by the logic component; negotiating the access layer parameter with a network serving the UE; receiving a configuration from the network, the configuration being related to the access layer parameter; and communicating with the network according to the access layer parameter.

In an additional aspect of the disclosure, an apparatus includes a transceiver; and a processor coupled to the transceiver and configured to: communicate from an operating system to a logic component by an application programming interface (API), including communicating an operational characteristic of the apparatus to the logic component, which is separate from the operating system and executed by the processor; cause the logic component to determine an access layer parameter value from the operational characteristic; negotiate the access layer parameter value with a new radio (NR) network; receive a configuration from the network in response to the access layer parameter value; and cause the transceiver to communicate with the network according to the access layer parameter value.

In another aspect of the disclosure, a non-transitory computer-readable medium having program code recorded thereon, the program code includes code for mapping an access layer parameter to an operational characteristic of a user equipment (UE), where the code for mapping is included within a software framework that is isolated from direct end user input; code for recommending a configuration of the access layer parameter based on the mapping, including code for transmitting a UE assistance information (UAI) information element (IE) referencing the access layer parameter to a network; code for receiving configuration information from the network specifying a value for the access layer parameter and in response to the UAI; and code for performing uplink and downlink communications with the network according to the value for the access layer parameter.

In yet another aspect of the disclosure, a user equipment (UE) includes means for communicating an operational characteristic of the UE from an operating system of the UE to a software framework that is separate from the operating system of the UE; means for mapping an access layer parameter value to the operational characteristic, means for transmitting an indication of the access layer parameter value to a base station serving the UE, and means for configuring the UE to communicate with the base station according to the access layer parameter value and according to configuration information from the base station.

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates an example network, including a UE and a base station, according to some aspects of the present disclosure.

FIG. 4 illustrates an example communication flow between a UE and a network, and frequencies according to some aspects of the present disclosure.

FIG. 5 illustrates a block diagram of a process for selecting or mapping the operational characteristics to access layer parameters, according to some aspects of the present disclosure.

FIG. 6 is a block diagram of a user equipment (UE) according to some aspects of the present disclosure.

FIG. 7 is a block diagram of an exemplary base station (BS) according to some aspects of the present disclosure.

FIG. 8 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

There are a variety of different access layer parameters, which determine the operation of a user equipment (UE). Nonlimiting examples include discontinuous reception (DRX) inactivity timer settings, long and short DRX cycles, multiple input multiple output (MIMO) layer settings, and the like. Such parameters tend to be numerous and go directly to lower layer operations of a UE chipset, such as a modem chipset.

While it might be possible to give a user direct control over some access layer settings, the numerosity and technicality of the settings may be undesirable to expose to an end-user. Furthermore, some access layer settings may be negotiated with a network in accordance with a UE Assistance Information (UAI) information element (IE) (UAI IE, also referred to as a UAI for short). The UAI allows the UE to indicate its preference for a parameter, assuming that the UE is configured to do so. For instance, the UE may indicate a preference for a parameter using the UAI on an uplink signal to the network. The network may process the information in the UAI and then use one or more algorithms to determine whether it should configure the UE with those parameters. For instance, it may be that the requested parameter in the UAI would cause an undesirable amount of resource usage, so the network may decline to configure the UE according to the UAI. However, on the other hand, the requested parameter may be acceptable to the network, in which case the network may configure the UE according to the UAI. In short, protocols using UAI are optional for the network, and they allow the UE to indicate or negotiate preferences with the network.

Referring again to the problem of user access to access layer settings, while it might be possible to allow a user to indicate access layer parameters and to have the UE communicate those preferences via a UAI, such procedure may be less than desirable for the reasons discussed above.

According to some implementations of the present disclosure, techniques for setting access layer parameters are provided. In one example, the access layer parameters are hidden behind a framework, which may include software logic that runs on an application, in an operating system, or on a modem chip or application processor of the UE. Access layer parameter preferences may be determined in any of a variety of ways. For instance, the framework may receive input specifying an operational characteristic of the UE, such as through user input, user habit information, user profile information, battery remaining or charging state information, connectivity status, accessory status, and the like.

Continuing with the example, an operating system of the UE communicates to a logic component through an application programming interface (API). The communications may include an indication of the input. The logic component may include a software framework which is separate from the operating system and is executed by a chip set of the UE. The logic component may then map the operational characteristic of the UE to one or more access layer parameters. For instance, if the operational characteristic of the UE indicates that lower power use is desired, then the logic component may map that operational characteristic to a bandwidth setting, a DRX setting, a setting for number of layers for MIMO, and/or the like.

The logic component may then negotiate the access layer parameter with a network that is serving the UE. Negotiating the access layer parameter may include indicating a preference for a value of the access layer parameter by transmitting a UAI IE to the network as part of an uplink communication. The network may or may not determine to configure the UE according to the preferences transmitted in the UAI. For some of the access layer parameters, the network may determine to use a configuration that is the same as the preference transmitted in the UAI, is different from the preference transmitted in the UAI, or the network may take no action at all. After some time, the UE may or may not re-transmit the UAI with a parameter that was not agreed to by the network.

Assuming that the network determines to configure the UE according to the preference transmitted in the UAI, the UE may then receive a configuration from the network. The UE then sets its access layer parameters according to the configuration and then communicates with the network according to the settings that correspond to the access layer parameter.

Aspects of the present disclosure may provide several benefits. For example, some implementations may provide a more fine-grained access to lower-layer parameters, thereby increasing performance of the UE. In some examples, the increased performance may include increased power savings, increased uplink or downlink throughput, or the like. Even though the access to the lower layer parameters is more fine-grained, the complexity is still hidden from an end-user because the responsibility for negotiating the parameter values is assigned to a logic component which is separate from the operating system of the UE.

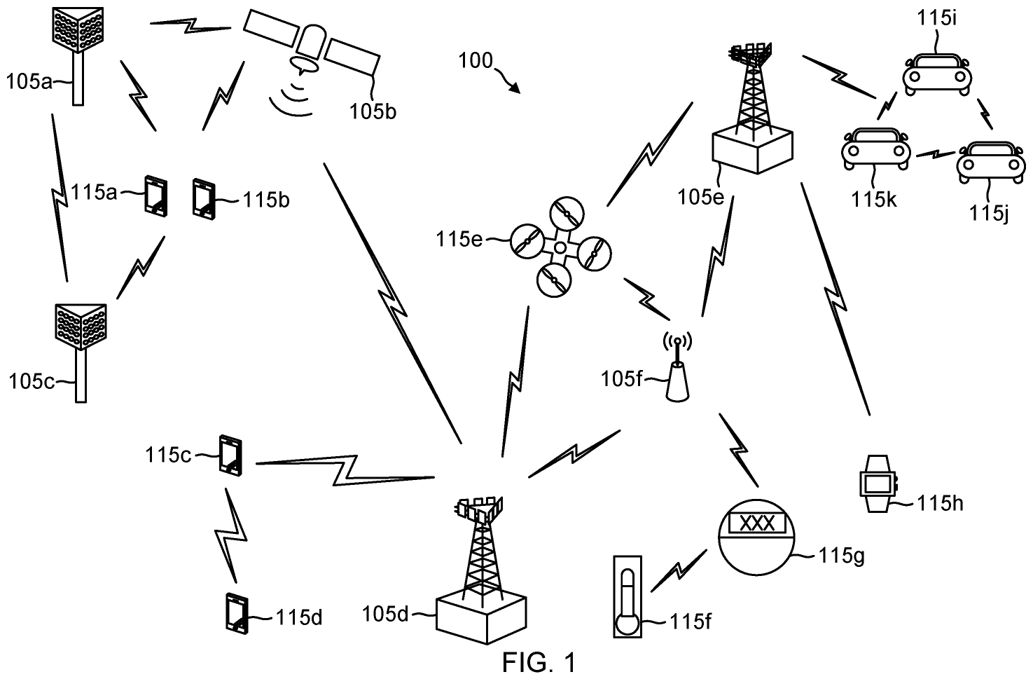

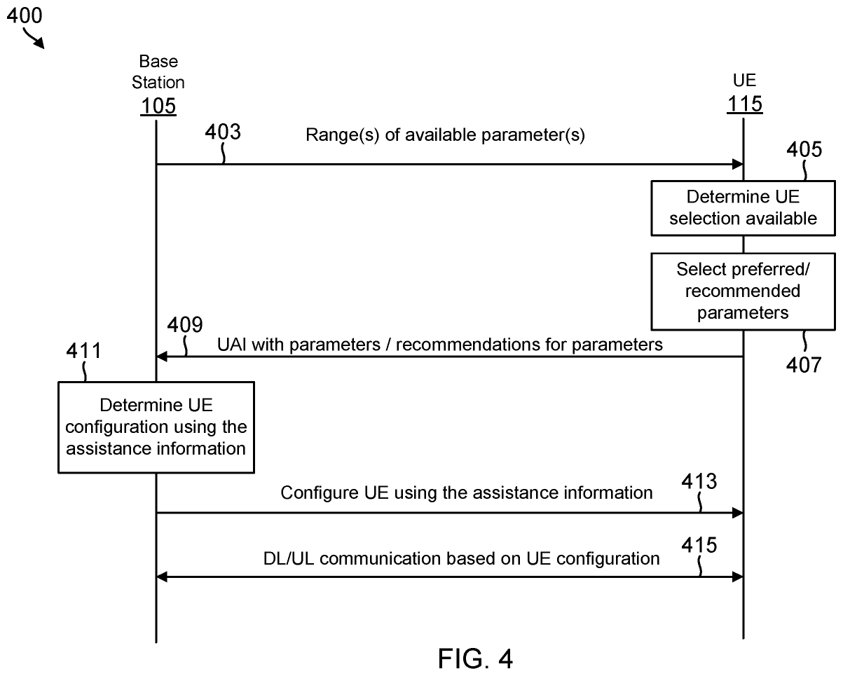

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. The actions of FIGS. 4, 5, and 8 may be performed by any of UEs 115.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105b, 105d, and 105e may be regular macro BSs, while the BSs 105a and 105c may be macro BSs enabled with one of three dimension (3D), full dimension (FD), or massive MIMO. The BSs 105a and 105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, an Internet of Things (IoT) device, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a and 105c may serve the UEs 115a and 115b using 3D beamforming and coordinated spatial techniques, such as coordinated multipoint (COMP) or multi-connectivity. The macro BS 105d may perform backhaul communications with the BSs 105a and 105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support communications with ultra-reliable and redundant links for devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mmWave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access.

In some aspects, the network 100 may be an IoT network and the UEs 115 may be IoT nodes, such as smart printers, monitors, gaming nodes, cameras, audio-video (AV) production equipment, industrial IoT devices, and/or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band.

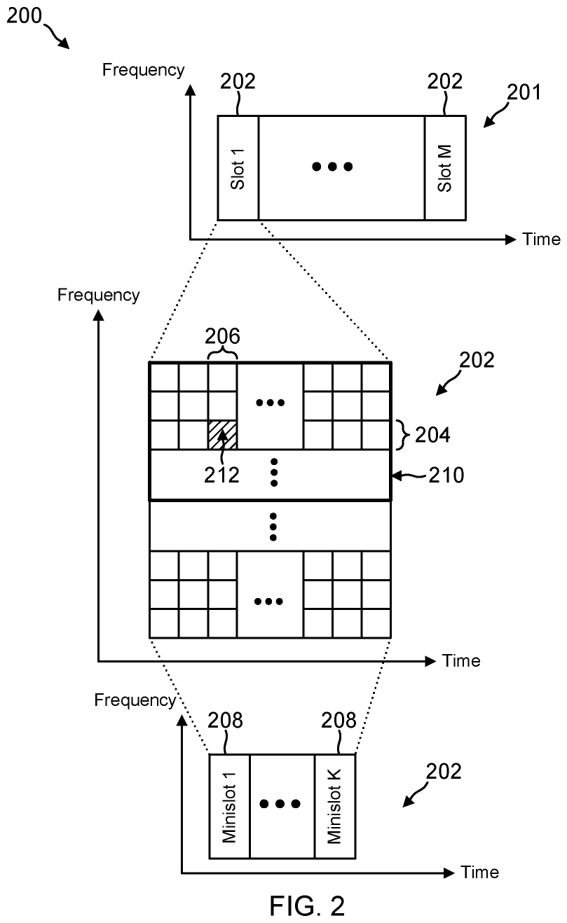

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the cellular processor (CP) mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

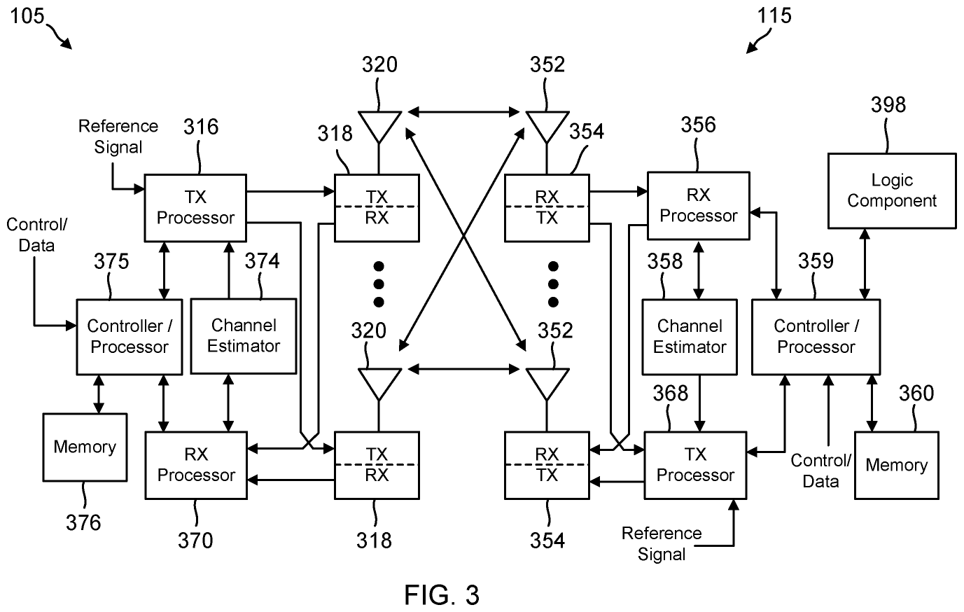

FIG. 3 illustrates a base station 105 in communication with a UE 115 in wireless communications network, such as network 100 of FIG. 1. In this example, the controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, system information blocks, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

In certain aspects, the base station 105 may include functionality configured to receive UE configuration parameter(s) from UE 350 having at least one preferred parameter for a UE configuration, e.g., to configure the UE using UE configuration parameter(s) received from the UE 115.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 115, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These decisions may be based on channel estimates computed by the channel estimator 358. The decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160.

Similar to the functionality described in connection with the DL transmission by the base station 105, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

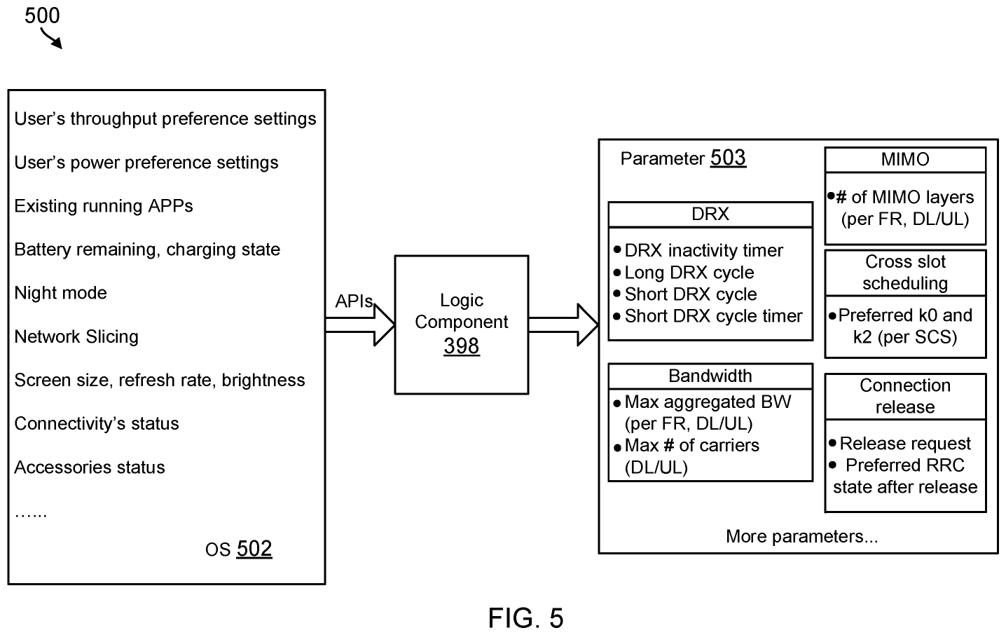

In certain aspects, the UE 115 may include a logic component 398 configured to transmit UE configuration parameter(s) to base station 105 and having at least one preferred parameter for a UE configuration, e.g., to receive a configuration from the base station based, at least in part, on the UE configuration parameter(s) transmitted to the base station 105. In this example, logic component 398 is shown as a software framework that is run on controller/processor 359. In one embodiment, controller/processor 359 includes a chipset that has at least an application processor and a modem; in other embodiments, the controller/processor 359 includes a system on chip (SOC) that includes a CPU, the modem, and other components on a single chip. In any event, the logic component 398 is separate from an operating system running on the controller/processor 359, and a logic component 398 communicates with the operating system via, e.g., an application programming interface (API). This is explained in more detail with respect to FIG. 5.

Channel estimates derived by a channel estimator 358 from a reference signal or feedback transmitted by the base station 105 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 105 in a manner similar to that described in connection with the receiver function at the UE 350. Each receiver 318RX receives a signal through its respective antenna 320. Each receiver 318RX recovers information modulated onto an RF carrier and provides the information to a RX processor 370. The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350.

FIG. 4 illustrates an example communications flow according to some aspects of the present disclosure. Specifically, FIG. 4 shows a communications flow 400 between an example base station 105, associated with the network, and an example UE 115 that is served by the network. The network may control many aspects of the radio configurations for the UE 115. However, the UE 115 may have a better understanding of some factors than the network. For example, the UE 115 may be aware of the UE's power status, e.g., including an anticipated battery life. The UE 115 may also be aware of user changes to power preferences, e.g., when a user switches to a low power mode in a user menu at the UE 115. The UE 115 may also be aware that an application is active or is anticipated to be active. In one example, an operating system of the UE 115 may track operational characteristics of the UE, such as power and charging status, nighttime mode, user operating habits, activity of applications, and the like. The operating system may then pass an indication of those operational characteristics to a logic component, such as logic component 398 of FIG. 3. The logic component may then use those operational characteristics to determine appropriate parameter values for layers, 1, 2, and/or 3 (e.g., access layer parameters) and transmit preferences/recommendations to the network.

Beginning at action 403, the base station 105 may provide a range of available parameters to the UE 115. Then at action 405, the UE 115 may match those available parameters of the network to available operating parameters of the UE 115 and then perform action 407 only with respect to those parameters that are supported by both the base station 105 and the UE 115.

As illustrated at action 407, the logic component (e.g., logic component 398 of FIG. 3) may select parameters for radio configurations for the UE 115. The selection may be based on different purposes. The UE 115 may classify UE configuration parameters into different categories based on different purposes or user preferences. One example purpose may be a power saving purpose. Other examples of purposes may include performance, improved communication, or the like. For example, the UE 115 may signal certain DRX parameters when the UE measures traffic patterns and estimates an optimal set of DRX parameters based on the measured traffic. As another example, the UE 115 may signal beam management parameters when the UE 115 will adjust its receiving beam or transmission beam. Thus, the selected parameters may correspond to preferences or recommendations from the UE 115 for UE radio parameters.

At action 409, the UE 115 may indicate the selected parameters to the base station 105. The selected parameters/UE preferences for radio configurations may be referred to as assistance information, such as UE assistance information and may include values for access layer parameters. The assistance information may inform the base station that the UE 115 would prefer to prioritize power savings over performance, for example. When a user switches the UE 115 to a lower power mode, the UE 115 may indicate preferences to the base station 105 that will affect power savings. For instance, the UE 115 may select the parameters and/or parameter values based on a knowledge of which applications are active at the UE 115 and/or will become active at the UE 115.

The UE 115 may provide the assistance information to the base station, such as in an Information Element (IE). For example, the assistance information may be included in a UE Assistance IE (UAI) on a PUSCH or other UL appropriate channel.

The base station 105 may use the assistance information, at action 411, to determine the radio configurations for the UE 115. The assistance information may be one of various factors considered by the base station 105 in configuring the UE 115. The base station 105 may not be constrained by the preferences indicated to the base station at 409 but may instead be free to use the information to configure the UE 115 in a more effective manner.

At action 413, the base station 105 may configure the UE 115 with the configuration determined at action 411 using the assistance information provided by the UE. For example, the base station 105 may use RRC or other appropriate mechanism to configure the UE 115 accordingly. The base station 105 and UE 115 may then implement the configuration in communicating with each other. As illustrated at action 415, the base station 105 may communicate uplink and/or downlink communication with the UE 115 based on the configuration of the UE at 413.

FIG. 5 is an illustration of an example operating flow 500 of a UE, such as UE 115 of FIG. 1, according to one embodiment. The operating system (OS) 502 includes indications of operational characteristics of the UE. The indications of operational characteristics are received by the logic component 398 via APIs. The logic component 398 then determines values of one or more access layer parameters 503 to request from the network using UAI.

For example, a non-exhaustive list of operational characteristics may include: a user's throughput preference settings, user's power preference settings, applications that are running, battery state, charging state, night mode, network slicing, display characteristics (e.g., screen size, refresh rate, brightness), connectivity status, accessory status, and the like. Such information may be communicated to the logic component 398 by one or more APIs. The logic component 398 may then determine one or more parameters 503 that would be appropriate based on the operational characteristics. A nonexclusive list of operating parameters 503 includes: DRX parameters, such as DRX inactivity timer, long cycle, short cycle, short cycle timer, MIMO parameters, such as a number of MIMO layers, cross-slot scheduling, bandwidth parameters, such as maximum aggregated bandwidth or maximum number of carriers, connection release parameters, such as a release request and preferred RRC state after release, and the like.

In one example, the operational characteristic may correspond to a user's throughput preference settings. In response, the logic component 398 may then select MIMO and/or bandwidth parameters to accomplish the throughput preference settings. In another example, the operational characteristic may correspond power preference settings, and the logic component 398 may select DRX, MIMO and/or bandwidth settings to accomplish the power preference settings. In another example, the operational characteristic indicates that the user is engaging in online gaming, and the logic component 398 may then select an appropriate MIMO or bandwidth setting, depending upon the data use and power use of the game. In yet another example, the operational characteristic may correspond to an amount of battery remaining or a charging state of the UE, and the logic component 398 may select a large DRX, a low bandwidth, and fewer MIMO layers if the battery is low or may free up other limitations to allow best performance of the UE if the UE is charging. In another example, the operational characteristic corresponds to a night mode of the UE, and in response the logic component 398 may select DRX parameters, bandwidth parameters, and MIMO parameters to save power. An example in which the operational characteristics correspond to a network slicing setting, the logic component 398 may select a bandwidth parameter to accommodate a high throughput and/or select a particular DRX parameter to reduce latency. In an example in which the operational characteristic corresponds to a display screen being off, then the logic component 398 may select a more restrictive setting of any one of the parameters to get a power saving affect and then ask for a connection release. In an example in which the operational characteristic corresponds to a wireless access point is in a sleep mode, the logic component 398 may ask for a connection release. In an example in which the operational characteristic corresponds to Wi-Fi being turned on at the UE, the logic component 398 may select bandwidth parameters, MIMO parameters, DRX parameters to save power by using fewer NR resources and more Wi-Fi resources.

Of course, such examples are merely examples, and the scope of implementations includes the logic component 398 setting a value for any appropriate parameter 503 in response to any appropriate operational characteristic input from the OS 502. Furthermore, the logic component 398 is separate from the OS 502. In one example, the logic component 398 may be a software framework that runs on a modem chip or an application processor chip of the UE 115. In another example, the logic component 398 may include an application that runs on top of operating system 502. In either example, the software code of logic component 398 may be separate from the code of the operating system 502. Such separation may allow for effective and efficient selection of parameters 503 while not exposing to an end-user the ability to request parameters 503. Specifically, access layer parameters, such as parameters 503, may be beneficially set by an entity that can monitor the operation, network performance, and channel conditions relevant to the UE 115, and allowing an end user to set the parameters may result in selection of inappropriate parameters or parameters that make performance worse. For instance, a user may be unaware of the technical details of a channel condition as it relates to a number of MIMO layers or bandwidth, whereas logic component 398 may have access to that information from its own monitoring of the UE as well as from receiving operational characteristics from the operating system 502. Therefore, logic component 398 may be in a better position to select values of parameters 503 than would be an end-user. Furthermore, operation of the logic component 398 as described herein may provide for improved performance of the UE with respect to power and throughput than would be expected through selection of parameter values by an end-user.

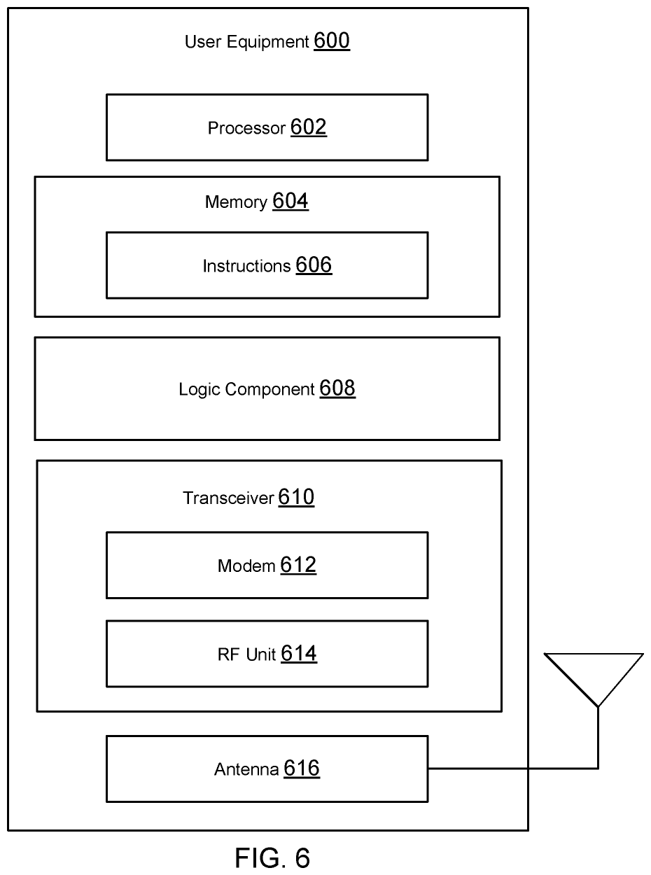

FIG. 6 is a block diagram of an exemplary UE 600 according to some aspects of the present disclosure. The UE 600 may be a UE 115 discussed above in FIGS. 1 and 3. As shown, the UE 600 may include a processor 602, a memory 604, a logic component 608, a transceiver 610 including a modem subsystem 612 and a radio frequency (RF) unit 614, and one or more antennas 616. These elements may be in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to the UEs 115 in connection with aspects of the present disclosure, for example, aspects of FIGS. 3-5, and 8. Instructions 606 may also be referred to as program code. The program code may be for causing a wireless communication device to perform these operations, for example by causing one or more processors (such as processor 602) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The logic component 608 may correspond to logic component 398 and may be implemented via hardware, software, or combinations thereof. For example, the logic component 608 may be implemented as instructions 606 stored in the memory 604 and executed by the processor 602. In some instances, the logic component 608 can be integrated within, and executed by, the modem subsystem 612. For example, the logic component 608 can be implemented by a combination of software components (e.g., executed by a DSP or a general processor) and hardware components (e.g., logic gates and circuitry) within the modem subsystem 612.

The logic component 608 may be used for various aspects of the present disclosure, for example, aspects of FIGS. 3-5 and 8. The logic component 608 is configured to receive indications of operational characteristics of the UE 600 and then to select one or more access layer parameters appropriate for the operational characteristics. The logic component 608 may also cause an indication of access layer parameter values to be transmitted to the network via UAI, as described above.

As shown, the transceiver 610 may include the modem subsystem 612 and the RF unit 614. The transceiver 610 can be configured to communicate bi-directionally with other devices, such as the BSs 105. The modem subsystem 612 may be configured to modulate and/or encode the data from the memory 604 and/or the logic component 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., PUCCH control information, PRACH signals, PUSCH data, and the like) from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together at the UE 115 to enable the UE 115 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The transceiver 610 may provide the demodulated and decoded data (e.g., SSBs, PDCCH, PDSCH, beam switch command, CSI-RS resource configuration, CSI-RS reporting configuration, BFR resource configuration) to the logic component 608 for processing. The antennas 616 may include multiple antennas of similar or different designs in order to sustain multiple transmission links. The RF unit 614 may configure the antennas 616.

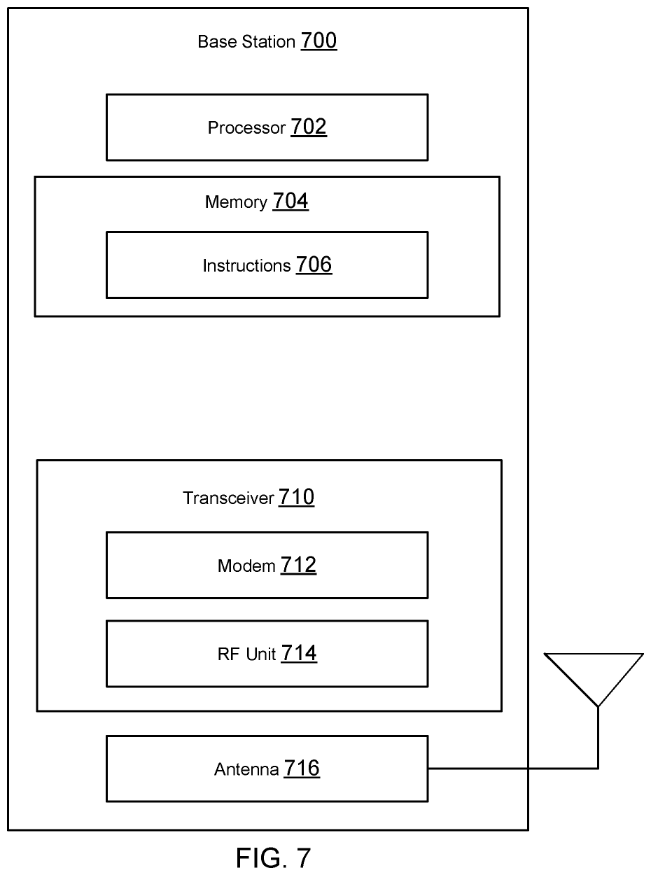

FIG. 7 is a block diagram of an exemplary BS 700 according to some aspects of the present disclosure. The BS 700 may be a BS 105 in the network 100 as discussed above in FIG. 1. A shown, the BS 700 may include a processor 702, a memory 704, a transceiver 710 including a modem subsystem 712 and a RF unit 714, and one or more antennas 716. These elements may be in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the processor 702 to perform operations described herein, for example, determining appropriate configurations based on among other things UAI. Instructions 706 may also be referred to as code, which may be interpreted broadly to include any type of computer-readable statement(s) as discussed above with respect to FIG. 6.

As shown, the transceiver 710 may include the modem subsystem 712 and the RF unit 714. The transceiver 710 can be configured to communicate bi-directionally with other devices, such as the UEs 115 and/or another core network element. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., SSBs, RMSI, MIB, SIB, frame based equipment—FBE configuration, PRACH configuration PDCCH, PDSCH) from the modem subsystem 712 (on outbound transmissions) or of transmissions originating from another source such as a UE 115, the node 315, and/or US 700. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 105 to enable the BS 105 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may be similar to the antennas 302 of the BS 305 discussed above. This may include, for example, transmission of information to complete attachment to a network and communication with a camped UE 115 or 215 according to some aspects of the present disclosure. The antennas 716 may further receive data messages transmitted from other devices and provide the received data messages for processing and/or demodulation at the transceiver 710. The transceiver 710 may provide the demodulated and decoded data (e.g., PUCCH control information, PRACH signals, PUSCH data) to the beam module 708 for processing. The antennas 716 may include multiple antennas of similar or different designs in order to sustain multiple transmission links.

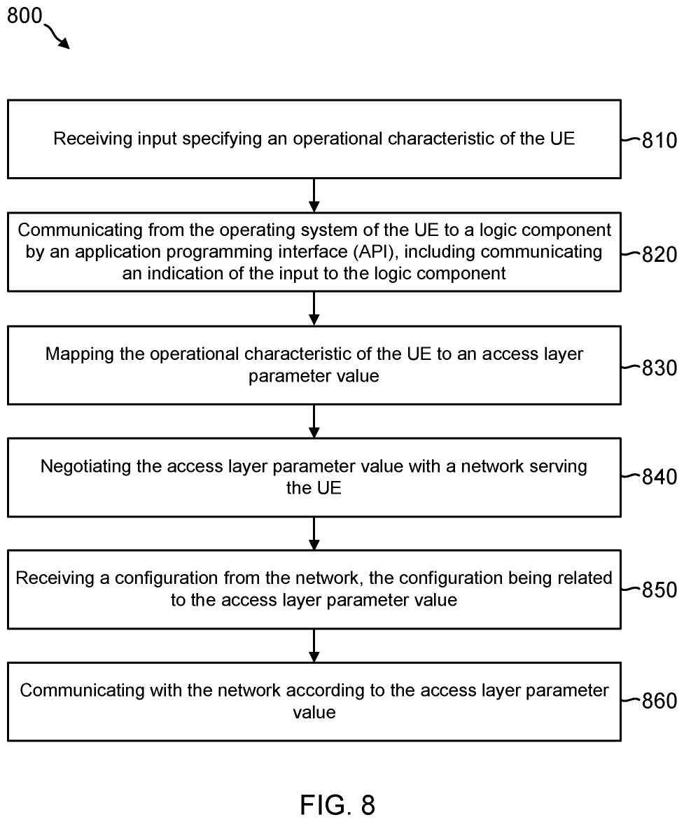

FIG. 8 is a flow diagram of a communication method 800 according to some aspects of the present disclosure. Actions of the method 800 can be executed by a computing device (e.g., a processor, processing circuit, and/or other suitable component) of an apparatus or other suitable means for performing the steps. For example, a UE, such as the UEs 115 and/or the UE 600, may utilize one or more components, such as the processor 602, the memory 604, the logic component 608, the transceiver 610, and the one or more antennas 616, to execute the steps of method 800. For instance, the method may be performed by an application processor, a modem chipset, and SOC hosting an application processor and modem chipset, or the like.

As illustrated, the method 800 includes a number of enumerated actions, but aspects of the method 800 may include additional steps before, after, and in between the enumerated actions. In some aspects, one or more of the enumerated actions may be omitted or performed in a different order.

At block 810, a component of the UE, such as the operating system, receives input specifying an operational characteristic of the UE. The input may be received directly from a user via a user interface (UI), such as by the user changing a setting or mode of the UE. The input may also be derived from user habit information or user profile information, such as a user's application preferences, a user's power preferences, and the like. Examples are provided within OS 502 of FIG. 5, which includes a non-exhaustive list of different user operational characteristics that may be received by the OS 502.

At block 820, there is communication from the OS to a logic component (e.g., logic component 398 of FIG. 3) via an API. The communications may include an indication of the input. Any API now known or later developed may be used as appropriate in the various implementations. Block 820 illustrates that there is separation between the OS itself and the logic component such that the information may be conveyed via API. In other words, the logic component itself is not exposed directly to input from the end user, but rather is situated so that it receives the communication at block 820 and then acts on the information, such as described with respect to blocks 830-860.

At block 830, the logic component maps the operational characteristic of the UE to an access layer parameter. Examples are given above with respect to FIG. 5, where access layer parameters include those parameters included within protocol layers 1-3. In one example implementation, the operational characteristic indicates that the UE should be conserving power, and the logic component then maps that operational characteristic to DRX parameters, bandwidth parameters, and/or MIMO layer parameters to reduce an amount of power consumed. Of course, that is just one example, and a non-exhaustive variety of examples are given above with respect to FIG. 5. A result of the actions of block 830 include that the logic component has selected one or more access layer parameter values to be recommended and/or requested from the network.

At block 840, the logic component then negotiates the access layer parameter with a network that is serving the UE. For instance, the logic component may provide an indication of the access layer parameter values in a UAI IE transmitted on a PUSCH. The network may then receive the UAI IE and determine whether to adopt the access layer parameter value. In some instances, the network may determine not to adopt the access layer parameter value, such as where the value may be impractical and/or likely to result in worse performance for the network. The logic component may or may not subsequently send a modified parameter request. In some instances, the network may determine to adopt the access layer parameter value.

There may be various different parameters that the UE may indicate to the base station in the assistance information in the UAI. The UE may send its preferred values of each of the parameters to the base station in a single UAI. In another example, the UE may send a subset of the preferred parameter values to the base station in a first UAI. The UE may send another subset of the preferred parameter values to the base station in another UAI. The UE may send a single preferred parameter value or indication to the base station in the UAI. Thus, the UE may communicate assistance information to the base station in a grouping and order determined by the UE.

At block 850, the logic component receives a configuration from the network, assuming that the network has adopted the access layer parameter value received at block 840. For instance, the UE may receive an RRC configuration from the network, where the RRC configuration indicates to the UE to configure itself with the access layer parameter value from block 840.

At block 860, the UE and the network communicate according to the access layer parameter value. For instance, if the access layer parameter includes a particular DRX cycle, then the UE and the network will operate together according to the DRX cycle. The same may be true for MIMO layers, cross-slot scheduling, connection release, bandwidth parameters, and any other appropriate access layer parameters.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

Various embodiments are further described with respect to the enumerated clauses below:
1. A method of wireless communication performed by a user equipment (UE), the method comprising:
receiving input specifying an operational characteristic of the UE;
communicating from an operating system of the UE to a logic component by an application programming interface (API), including communicating an indication of the input to the logic component, which is separate from the operating system and executed by a chipset of the UE;
mapping the operational characteristic of the UE to an access layer parameter value, wherein mapping the operational characteristic is performed by the logic component;
negotiating the access layer parameter value with a network serving the UE;
receiving a configuration from the network, the configuration being related to the access layer parameter value; and
communicating with the network according to the access layer parameter value.
2. The method of clause 1, wherein negotiating the access layer parameter value comprises:
transmitting a UE assistance information (UAI) information element (IE) from the UE to the network, the UAI IE indicating a value of the access layer parameter.
3. The method of clause 2, wherein the UE transmits the UAI IE on a physical uplink control channel (PUSCH).
4. The method of clauses 1-3, wherein the logic component is executed by a modem of the UE.
5. The method of clauses 1-3, wherein the logic component is executed by an application processor of the UE.
6. The method of clauses 1-5, wherein the access layer parameter value corresponds to at least one item selected from a list consisting of:
a discontinuous reception (DRX) parameter;
a first bandwidth parameter indicating a number of carriers;
a second bandwidth parameter indicating a maximum aggregated bandwidth;
a multiple input multiple output (MIMO) parameter indicating a number of MIMO layers;
a cross-slot scheduling parameter; and
a connection release parameter.
7. The method of clauses 1-6, wherein the access layer parameter value corresponds to at least one item selected from a list consisting of:
a radio resource control (RRC) layer parameter;
a packet data convergence protocol (PDCP) layer parameter,
a radio link control (RLC) layer parameter;
a medium access control (MAC) layer parameter; and
a physical (PHY) layer parameter.
8. The method of clauses 1-7, wherein the operational characteristic comprises a power saving characteristic, and wherein the access layer parameter value corresponds to a discontinuous reception (DRX) parameter.
9. The method of clauses 1-8, wherein the input comprises user input received via a user interface (UI) of an application running on the operating system of the UE.
10. The method of clauses 1-9, wherein the input comprises either or both of user habit information and user profile information.
11. The method of clauses 1-10, wherein the input is from a first protocol layer higher than a second protocol layer associated with the access layer parameter value.
12. An apparatus comprising:
a transceiver; and
a processor coupled to the transceiver and configured to:
   communicate from an operating system to a logic component by an application programming interface (API), including communicating an operational characteristic of the apparatus to the logic component, which is separate from the operating system and executed by the processor;
   cause the logic component to determine an access layer parameter value from the operational characteristic;
   negotiate the access layer parameter value with a new radio (NR) network;
   receive a configuration from the network in response to the access layer parameter value; and
   cause the transceiver to communicate with the network according to the access layer parameter value.
13. The apparatus of clause 12, wherein the logic component is separate from the operating system it is executed by a chipset of the apparatus.
14. The apparatus of clauses 12-13, wherein the access layer parameter value corresponds to an access layer parameter within one of protocol layers 1-3.
15. The apparatus of clauses 12-14, wherein the processor is configured to:
transmit a UE assistance information (UAI) information element (IE) from the UE to the network, the UAI IE indicating the access layer parameter value.
16. The apparatus of clauses 12-15, wherein the operational characteristic comprises a power saving characteristic, and wherein an access layer parameter associated with the access layer parameter value comprises at least one item selected from a list consisting of:
a discontinuous reception (DRX) parameter;
a first bandwidth parameter indicating a number of carriers;
a second bandwidth parameter indicating a maximum aggregated bandwidth;
a multiple input multiple output (MIMO) parameter indicating a number of MIMO layers;
a cross-slot scheduling parameter; and
a connection release parameter.
17. The apparatus of clauses 12-16, wherein the processor comprises a modem chipset.
18. A user equipment (UE) comprising:
means for communicating an operational characteristic of the UE from an operating system of the UE to a software framework that is separate from the operating system of the UE;
means for mapping an access layer parameter value to the operational characteristic;
means for transmitting an indication of the access layer parameter value to a base station serving the UE; and
means for configuring the UE to communicate with the base station according to the access layer parameter value and according to configuration information from the base station.
19. The UE of clause 18, wherein the software framework is configured to run on a modem chipset of the UE.
20. The UE of clause 18, wherein the software framework is configured to run on an application processor of the UE.
21. The UE of clause 18, wherein the software framework comprises an application configured to run on the operating system.
22. The UE of clauses 18-21, further comprising:
means for inserting the indication of the access layer parameter value in a UE assistance information (UAI) information element on an uplink transmission to the base station.
23. The UE of clauses 18-22, wherein an access layer parameter associated with the access layer parameter value comprises at least one item selected from a list consisting of:
a radio resource control (RRC) layer parameter;
a packet data convergence protocol (PDCP) layer parameter,
a radio link control (RLC) layer parameter;
a medium access control (MAC) layer parameter; and
a physical (PHY) layer parameter.
24. The UE of clauses 18-23, further comprising:
means for receiving an indication of the operational characteristic from end user input.
25. The UE of clauses 18-24, further comprising
means for receiving an indication of the operational characteristic from end user habit information.
26. The UE of clauses 18-25, wherein the operational characteristic comprises a performance setting of the UE.
27. The UE of clauses 18-26, wherein the operational characteristic comprises a power setting of the UE.
28. A non-transitory computer-readable medium having program code recorded thereon, the program code comprising:
code for mapping an access layer parameter to an operational characteristic of a user equipment (UE), wherein the code for mapping is included within a software framework that is isolated from direct end user input;
code for recommending a configuration of the access layer parameter based on the mapping, including code for transmitting a UE assistance information (UAI) information element (IE) referencing the access layer parameter to a network;
code for receiving configuration information from the network specifying a value for the access layer parameter and in response to the UAI; and
code for performing uplink and downlink communications with the network according to the value for the access layer parameter.
29. The non-transitory computer-readable medium of clause 28, wherein the program code is stored on a modem chipset of the UE.
30. The non-transitory computer-readable medium of clauses 28-29, wherein the access layer parameter is selected from one of protocol layers 1-3.

What is claimed is:

1. A method of wireless communication performed by a user equipment (UE), the method comprising:
receiving input specifying an operational characteristic of the UE;
communicating from an operating system of the UE to a logic component by an application programming interface (API), including communicating an indication of the input to the logic component, which is separate from the operating system and executed by a chipset of the UE;
mapping the operational characteristic of the UE to an access layer parameter value, wherein mapping the operational characteristic is performed by the logic component;
negotiating the access layer parameter value with a network serving the UE;
receiving a configuration from the network, the configuration being related to the access layer parameter value; and
communicating with the network according to the access layer parameter value.

2. The method of claim 1, wherein negotiating the access layer parameter value comprises:
transmitting a UE assistance information (UAI) information element (IE) from the UE to the network, the UAI IE indicating the access layer parameter value.

3. The method of claim 2, wherein the UE transmits the UAI IE on a physical uplink control channel (PUSCH).

4. The method of claim 1, wherein the logic component is executed by a modem of the UE.

5. The method of claim 1, wherein the logic component is executed by an application processor of the UE.

6. The method of claim 1, wherein the access layer parameter value corresponds to at least one item selected from a list consisting of:
a discontinuous reception (DRX) parameter;
a first bandwidth parameter indicating a number of carriers;
a second bandwidth parameter indicating a maximum aggregated bandwidth;
a multiple input multiple output (MIMO) parameter indicating a number of MIMO layers;
a cross-slot scheduling parameter; and
a connection release parameter.

7. The method of claim 1, wherein the access layer parameter value corresponds to at least one item selected from a list consisting of:
a radio resource control (RRC) layer parameter;
a packet data convergence protocol (PDCP) layer parameter,
a radio link control (RLC) layer parameter;
a medium access control (MAC) layer parameter; and
a physical (PHY) layer parameter.

8. The method of claim 1, wherein the operational characteristic comprises a power saving characteristic, and wherein the access layer parameter value corresponds to a discontinuous reception (DRX) parameter.

9. The method of claim 1, wherein the input comprises user input received via a user interface (UI) of an application running on the operating system of the UE.

10. The method of claim 1, wherein the input comprises either or both of user habit information and user profile information.

11. The method of claim 1, wherein the input is from a first protocol layer higher than a second protocol layer associated with the access layer parameter value.

12. An apparatus comprising:
a transceiver; and
a processor coupled to the transceiver and configured to:
communicate from an operating system to a logic component by an application programming interface (API), including communicating an operational characteristic of the apparatus to the logic component, which is separate from the operating system and executed by the processor;
cause the logic component to determine an access layer parameter value from the operational characteristic;
negotiate the access layer parameter value with a new radio (NR) network;
receive a configuration from the network in response to the access layer parameter value; and
cause the transceiver to communicate with the network according to the access layer parameter value.

13. The apparatus of claim 12, wherein the logic component is separate from the operating system it is executed by a chipset of the apparatus.

14. The apparatus of claim 12, wherein the access layer parameter value corresponds to an access layer parameter within one of protocol layers 1-3.

15. The apparatus of claim 12, wherein the processor is configured to:
transmit a UE assistance information (UAI) information element (IE) from the UE to the network, the UAI IE indicating the access layer parameter value.

16. The apparatus of claim 12, wherein the operational characteristic comprises a power saving characteristic, and wherein an access layer parameter associated with the access layer parameter value comprises at least one item selected from a list consisting of:
a discontinuous reception (DRX) parameter;
a first bandwidth parameter indicating a number of carriers;
a second bandwidth parameter indicating a maximum aggregated bandwidth;
a multiple input multiple output (MIMO) parameter indicating a number of MIMO layers;
a cross-slot scheduling parameter; and
a connection release parameter.

17. The apparatus of claim 12, wherein the processor comprises a modem chipset.

18. A user equipment (UE) comprising:
means for communicating an operational characteristic of the UE from an operating system of the UE to a software framework that is separate from the operating system of the UE;
means for mapping an access layer parameter value to the operational characteristic;
means for transmitting an indication of the access layer parameter value to a base station serving the UE; and
means for configuring the UE to communicate with the base station according to the access layer parameter value and according to configuration information from the base station.

19. The UE of claim 18, wherein the software framework is configured to run on a modem chipset of the UE.

20. The UE of claim 18, wherein the software framework is configured to run on an application processor of the UE.

21. The UE of claim 18, wherein the software framework comprises an application configured to run on the operating system.

22. The UE of claim 18, further comprising:
means for inserting the indication of the access layer parameter value in a UE assistance information (UAI) information element on an uplink transmission to the base station.

23. The UE of claim 18, wherein an access layer parameter associated with the access layer parameter value comprises at least one item selected from a list consisting of:
a radio resource control (RRC) layer parameter;
a packet data convergence protocol (PDCP) layer parameter,
a radio link control (RLC) layer parameter;
a medium access control (MAC) layer parameter; and
a physical (PHY) layer parameter.

24. The UE of claim 18, further comprising:
means for receiving an indication of the operational characteristic from end user input.

25. The UE of claim 18, further comprising
means for receiving an indication of the operational characteristic from end user habit information.

26. The UE of claim 18, wherein the operational characteristic comprises a performance setting of the UE.

27. The UE of claim 18, wherein the operational characteristic comprises a power setting of the UE.

28. A non-transitory computer-readable medium having program code recorded thereon, the program code comprising:
code for mapping an access layer parameter to an operational characteristic of a user equipment (UE), wherein the code for mapping is included within a software framework that is isolated from direct end user input;
code for recommending a configuration of the access layer parameter based on the mapping, including code for transmitting a UE assistance information (UAI) information element (IE) referencing the access layer parameter to a network;
code for receiving configuration information from the network specifying a value for the access layer parameter and in response to the UAI; and
code for performing uplink and downlink communications with the network according to the value for the access layer parameter.

29. The non-transitory computer-readable medium of claim 28, wherein the program code is stored on a modem chipset of the UE.

30. The non-transitory computer-readable medium of claim 28, wherein the access layer parameter is selected from one of protocol layers 1-3.
